(19) United States
(12) Patent Application Publication
(10) Pub. No.: US 2010/0159908 A1
(43) Pub. Date: Jun. 24, 2010

(54) Apparatus and Method for Modifying Device Configuration Based on Environmental Information

(76) Inventors: Wen-Chi Chang, Taoyuan City (TW); Chih-Feng Hsu, Taoyuan City (TW); Kuo-Chen Wu, Taoyuan City (TW); Chin-Chung Shih, Taoyuan City (TW)

Correspondence Address: PERKINS COIE LLP;PATENT-SEA, P.O. BOX 1247, SEATTLE, WA, 98111-1247, US

(21) Appl. No.: 12/343,115

(22) Filed: Dec. 23, 2008

(51) Int. Cl. H04M 3/00

(52) U.S. Cl. 455/418

(57) ABSTRACT

A system for reconfiguring a mobile device based on environmental input is disclosed. The mobile device uses various components, including camera, microphone, and accelerometer, to gather data about the local environment. The system uses these components, separately or together, to determine the level of activity of the local environment. If the system determines that there is little activity in the local environment for a specified period of time, it enters low presence mode. In low presence mode, the system reconfigures the mobile device. The reconfiguration may include pausing or stopping applications, changing the device's volume settings, redirecting incoming telephone calls or text messages, or deactivating individual hardware components.

### BACKGROUND

As mobile technology improves, mobile devices have become smaller and more powerful. The wireless networks they connect to have improved, as well. These improvements mean that mobile devices can now connect to networks for many functions beyond simple voice calling. For example, they can be used to send e-mail, browse the Internet, and send instant messages. Many devices also include a Global Positioning System (GPS) receiver with integrated mapping (or maps downloaded from a network). In some cases, the mobile devices support wireless standards providing local connectivity, such as the 802.11 family of protocols or Bluetooth. These standards can enable the devices to connect to a WLAN or even communicate with other mobile devices in a peer-to-peer mode. Many mobile devices also include an integrated camera that allows a user to take pictures or record video. As technology improves, it would be useful to have applications that are better able to make use of these increased capabilities.

### BRIEF DESCRIPTION OF THE DRAWINGS

FIG. 1 is a front view of a mobile device suitable for implementing an environmental sensing system.

FIG. 2 is a block diagram of a representative environment in which a motion recognition user interface system operates.

FIG. 3 is a high-level block diagram showing an example of the architecture of a mobile device.

FIG. 4 illustrates a block diagram of an environmental sensing system.

FIG. 5 illustrates a flowchart of a process for implementing the environmental sensing system.

FIG. 6 illustrates a flowchart of a process for generating baseline environmental state data.

FIG. 7A illustrates a flowchart of a process for monitoring the local environment when the system is operating in a high presence mode.

FIG. 7B illustrates a flowchart of a process for monitoring the local environment while operating in low presence mode.

### DETAILED DESCRIPTION

A system for reconfiguring a mobile device based on environmental input is disclosed (hereinafter referred to as the “environmental sensing system” or the “system”). The mobile device uses various components, including camera, microphone, and accelerometer, to gather data about the local environment. The system uses these components, separately or together, to determine the level of activity of the local environment. If the system determines that there is little activity in the local environment for a specified period of time, it enters low presence mode. In low presence mode, the system reconfigures the mobile device. The reconfiguration may include pausing or stopping applications, changing the device's volume settings, redirecting incoming telephone calls or text messages, or deactivating individual hardware components.

In detecting activity, the system first determines a baseline environmental state of the local environment. In some embodiments, the system stores the baseline environmental state data at a time when the local environment is substantially static. The system then compares later environmental state data to the baseline environmental state data to detect when the local environment indicates substantially no activity in the local environment. The system then enters the low presence mode and reconfigures the mobile device. While in low presence mode, the system compares current environmental state data to the baseline environmental state data to detect resumed activity in the local environment. When new activity is detected, the system returns to high presence mode and reconfigures the mobile device accordingly. The system may also be configured to update the baseline environmental state data at later times, such as after detecting new activity in the local environment.

Various embodiments of the invention will now be described. The following description provides specific details for a thorough understanding and an enabling description of these embodiments. One skilled in the art will understand, however, that the invention may be practiced without many of these details. Additionally, some well-known structures or functions may not be shown or described in detail, so as to avoid unnecessarily obscuring the relevant description of the various embodiments. The terminology used in the description presented below is intended to be interpreted in its broadest reasonable manner, even though it is being used in conjunction with a detailed description of certain specific embodiments of the invention.

### I. Representative Environment

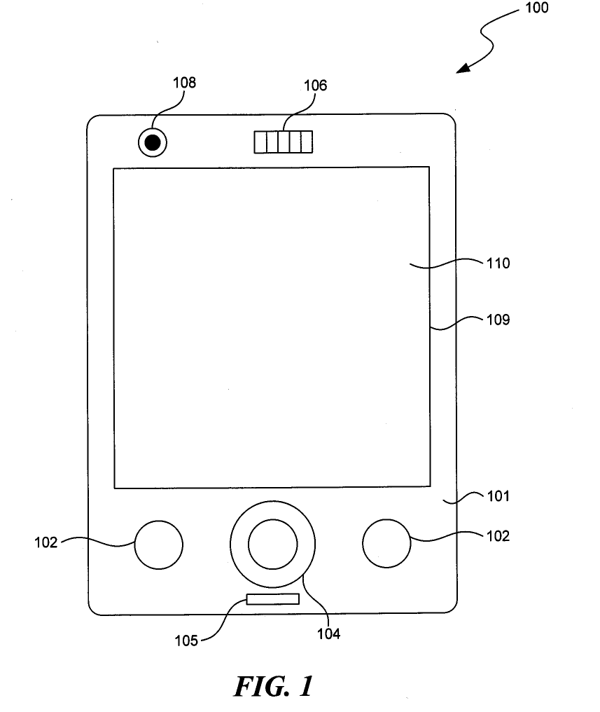

FIG. 1 is a front view of a mobile device suitable for implementing an environmental sensing system. As shown in FIG. 1, the mobile device 100 can include a housing 101, a plurality of push buttons 102, a directional keypad 104 (e.g., a five-way key), a microphone 105, a speaker 106, a camera 108, and a display 110 carried by the housing 101. The mobile device 100 can also include microphones, transceivers, photo sensors, and/or other computing components generally found in PDA devices, cellular phones, laptop computers, tablet PCs, smart phones, hand-held email devices, or other mobile communication/computing devices.

The display 110 can include a liquid-crystal display (LCD), a plasma display, a vacuum fluorescent display, a light-emitting diode (LED) display, a field emission display, and/or other suitable types of display configured to present a user interface. The mobile device 100 can also include a touch sensing component 109 configured to receive input from a user. For example, the touch sensing component 109 can include a resistive, capacitive, infrared, surface acoustic wave (SAW), and/or other types of touch screen. The touch sensing component 109 can be integrated with the display 110 or can be independent from the display 110. In the illustrated embodiment, the touch sensing component 109 and the display 110 have generally similarly sized access areas. In other embodiments, the touch sensing component 109 and the display 110 can have differently sized access areas. For example, the touch sensing component 109 can have an access area that extends beyond a boundary of the display 110.

The mobile device 100 can also include a camera 108 suitable for taking pictures or recording video. The camera 108 includes an optical image sensor and a lens, and may also have a flash associated with it for taking pictures in low-light conditions. Although the camera component 108 is shown on the front face of the mobile device 100, the camera component 108 could also be located on the rear face of the device. Alternatively, the mobile device 100 might be configured with multiple cameras, such as with a first camera on the front face and a second camera on the back face.

In certain embodiments, in addition to or in lieu of the camera component 108 and the touch sensing component 109, the mobile device 100 can also include a pressure sensor, a temperature sensor, a motion sensor, and/or other types of sensors (not shown) independent from or integrated with the display 110. For example, the mobile device 100 can include a thermocouple, a resistive temperature detector, and/or other types of temperature sensors proximate to the display 110 for measuring a temperature of an input mechanism, the display 110, and/or the touch sensing component 109. A motion sensor (such as an accelerometer) can be used to detect if the device is in motion and to determine the character of the motion.

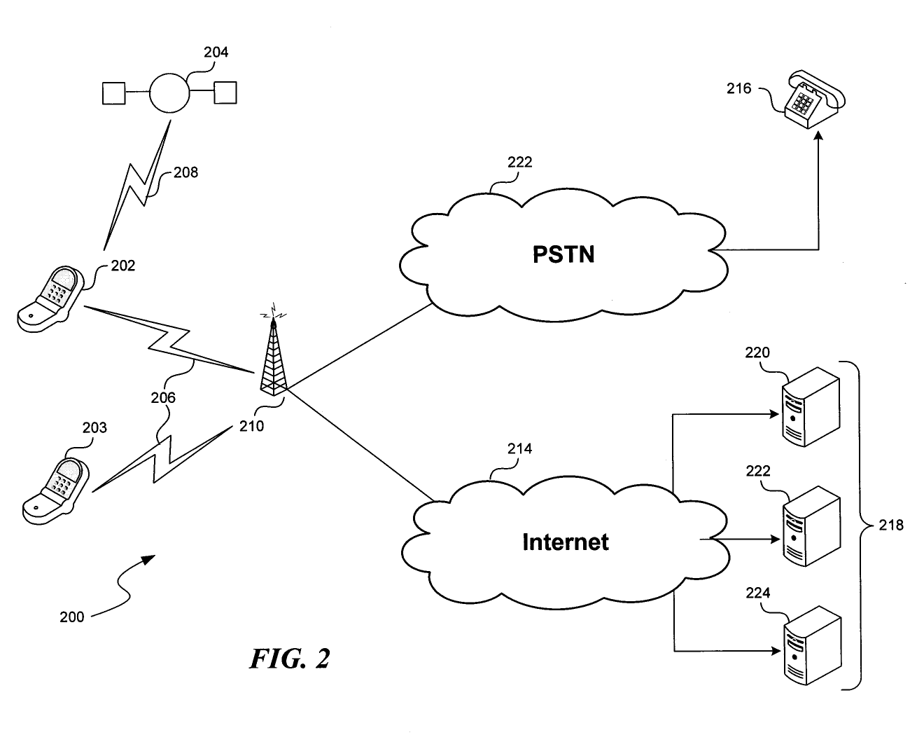

FIG. 2 is a block diagram of a representative environment 200 in which a motion recognition user interface system operates. A plurality of mobile devices 202 and 203 roam in an area covered by a wireless network. The mobile devices are, for example, cellular phones or mobile Internet devices. The mobile devices 202 and 203 communicate to a base station 210 through a wireless connection 206. The wireless connection 206 could be implemented using any system for transmitting digital data. For example, the connection could use a cellular network implementing UMTS or CDMA2000 or a non-cellular network implementing WiFi (IEEE 802.11) or Bluetooth. Although wireless connections are most common for these mobile devices, the devices could also communicate using a wired connection such as Ethernet. In some embodiments, the mobile devices 202 and 203 are configured to connect using multiple protocols depending on the situation. For example, the devices could be configured to use WiFi when possible and switch to a slower cellular network such as EDGE otherwise.

In some embodiments, the mobile device 202 also has a GPS receiver embedded in it to provide location information. In these embodiments, the mobile device 202 also receives a location signal 208 from one or more GPS satellites 204. For clarity, the figure only shows one satellite. However, a GPS-enabled device generally receives location signals 208 from several satellites, because a GPS receiver requires several satellites in order to determine its location. Also, although the mobile device 202 in FIG. 2 uses a satellite connection to determine location, it could also infer location based on its position relative to one or more base stations in a cellular network.

The base station 210 is connected to one or more networks that provide backhaul service for the wireless network. The base station 210 is connected to the Public-Switched Telephone Network (PSTN) 212, which provides a connection between the mobile network and a remote telephone 216 on another network. When the user of the mobile device 202 makes a voice telephone call, the base station 210 routes the call through the wireless network's voice backhaul (not shown) to the PSTN 212. The PSTN 212 then automatically connects the call to the remote telephone 216. If the remote telephone 216 is another mobile device, the call is routed through a second wireless network backhaul to another base station.

The base station 210 is also connected to the Internet 214, which provides a packet-based connection to remote devices 218 supporting network applications. When the user of the mobile device 202 makes a data connection, the base station routes the packet data through the wireless network's data backhaul (not shown) to the Internet 214 (or another packet-based network). The Internet 214 connects the wireless network to remote devices 218, including an e-mail server 220, a web server 222, and a direct push server 224. Of course, the remote devices could include any application available over the Internet, such as a file transfer protocol (FTP) server or a streaming media server. The remote devices 218 could also include other personal computers or mobile devices, where the mobile device 202 is connected through a peer-to-peer connection. Such a peer-to-peer connection could be used to provide voice services over a data network, such as through Voice over Internet Protocol (VoIP).

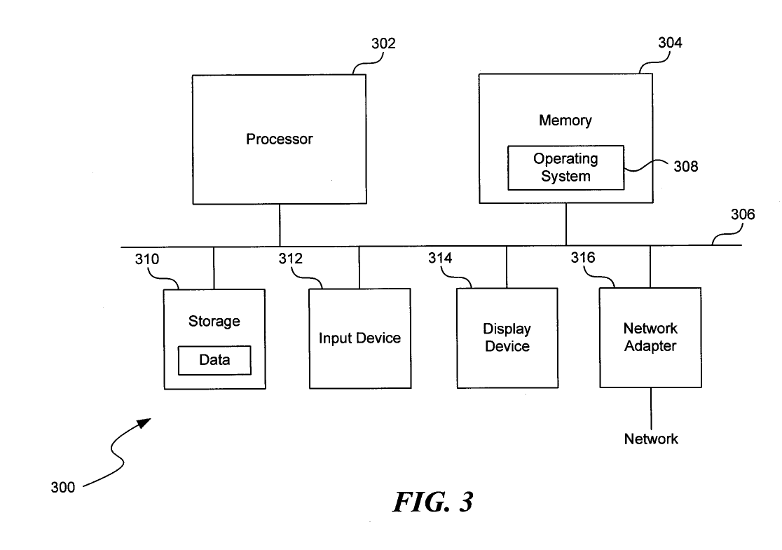

FIG. 3 is a high-level block diagram showing an example of the architecture of a mobile device 300. The mobile device 300 may represent the mobile device 202 of FIG. 2.

The mobile device 300 includes one or more processors 302 and memory 304 coupled to an interconnect 306. The interconnect 306 shown in FIG. 3 is an abstraction that represents any one or more separate physical buses, point-to-point connections, or both connected by appropriate bridges, adapters, or controllers. The interconnect 306, therefore, may include, for example, a system bus, a Peripheral Component Interconnect (PCI) family bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, sometimes referred to as “Firewire”.

The processor(s) 302 may include central processing units (CPUs) of the mobile device 300 and, thus, control the overall operation of the mobile device 300. In certain embodiments, the processor(s) 302 accomplish this by executing software or firmware stored in memory 304. The processor(s) 302 may be, or may include, one or more programmable general-purpose or special-purpose microprocessors, digital signal processors (DSPs), programmable controllers, application specific integrated circuits (ASICs), programmable logic devices (PLDs), or the like, or a combination of such devices.

The memory 304 is or includes the main memory of the mobile device 300. The memory 304 represents any form of fixed or removable random access memory (RAM), read-only memory (ROM), flash memory, or the like, or a combination of such devices. In use, the memory 304 stores, among other things, the operating system 308 of the mobile device 300.

The mobile device 300 includes an input device 312, which enables a user to control the device. The input device 312 may include a keyboard, trackpad, touch-sensitive screen, or other standard computer input device. The mobile device 300 also includes a display device 314 suitable for displaying a user interface. The network adapter 314 provides the mobile device 300 with the ability to communicate with remote devices over a network and may be, for example, a wireless adapter. The mobile device 300 may further include local storage 310 coupled to the interconnect 306. The local storage 310 may include, for example, a flash memory device configured to provide mass storage.

### II. Environment Sensing System

Despite the capabilities of current mobile devices, much processing capacity is wasted. Most of the time, a mobile device 100 does little except maintain connectivity with the wireless network. It would be useful to use this spare processing capacity to anticipate user needs and provide a better user experience. In particular, users do not always carry around their mobile devices. A user may, for example, leave the mobile device at his desk while he goes to a meeting. In those cases, it would be useful if the mobile device 100 could detect that there is no one present and reconfigure the system in response. For example, the mobile device 100 might be configured to redirect all calls to voice mail, rather than allow the phone to ring uselessly.

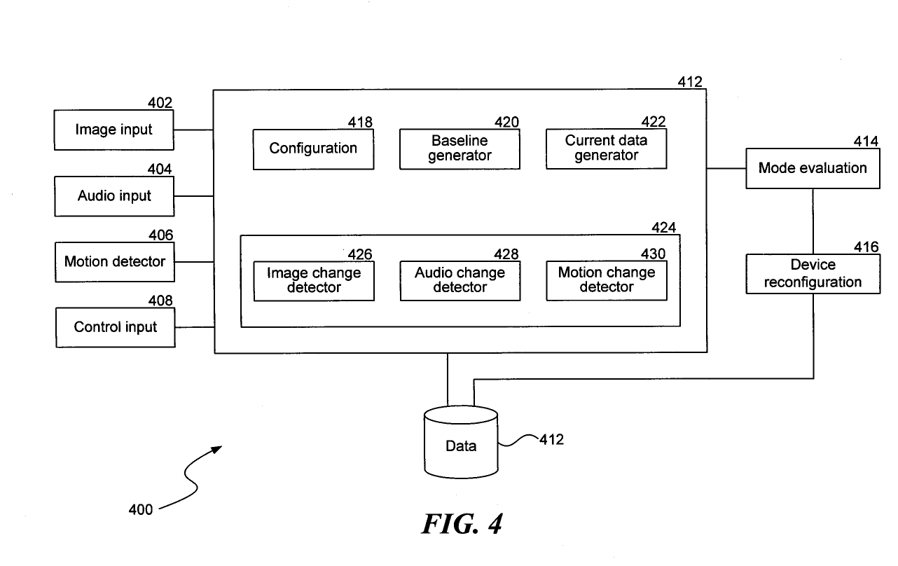

FIG. 4 illustrates a block diagram of an environmental sensing system 400. The system includes an image input component 402, which is configured to receive image data from the camera 108 or other optical input device. Image data is provided as a sequence of images received at a set interval, such as every tenth of a second. The system also includes an audio input component 404, which is configured to receive audio data from the microphone 105 or other audio input component. The system 400 includes a motion input component 406, which is configured to receive information about motion or acceleration of the mobile device. The motion input component 406 may receive motion information from a motion detector (e.g. accelerometer) in the mobile device, from a GPS receiver, or from another motion information source. The system 400 also has a control input component 408, which is configured to receive control input from other input components of the mobile device. For example, the control input component 408 could be configured to receive input from the touch screen 109 or the push buttons 102. The control input component 408 may be used to enable a user to configure the activity of the environmental sensing system. The environmental sensing system 400 also includes a data component 410, which provides persistent storage for system configuration and control settings.

The system 400 includes an environmental detector component 412, which detects changes in the local environment based on input received from the image input component 402, the audio input component 404, the motion input component 406, and from other sensor devices. The environmental detector component 412 is connected to a mode evaluation component 414, which uses the results from the environmental detector component 412 to characterize the activity in the local environment. As described below, the mode evaluation component 414 determines whether the mobile device 100 should operate in a low presence mode, where there is little activity in the local environment, or a high presence mode, where there is significant activity in the local environment. The mode evaluation component 414 provides this information to the device reconfiguration component 416, which reconfigures the components of the system depending on the mode selected by the mode evaluation component 414. The device reconfiguration component 416 can modify hardware or software settings of the mobile device. The specific settings to be modified are stored in the data component 410. The reconfiguration may be hard-coded by the original designer or manufacturer or may be modified at a later time (e.g. by the device user). The reconfiguration process is discussed in detail below.

The environmental detection component 412 includes a number of submodules to help execute its detection tasks. The environmental detection component 412 includes a configuration component 418, which receives input from the control input component 408 and interacts with the data store 410 to control configuration settings for the environmental detection component 412. For example, the configuration component 418 controls threshold and timing values for the system.

The environmental detection component 412 includes a baseline generator component 420 and a current data generator component 422, which are designed to generate environmental state data using input from the image input component 402, the audio input component 404, the motion input component 406, and from other sensor devices. The environmental state data defines the conditions of the local environment near the mobile device 100 at a specified time and may include an image representing the field of view of the camera 108, audio characteristics at the specified time, or a level of motion at the specified time. The baseline generator component 420 determines a baseline set of environmental state data that can be used for later comparison to detect changes in the environment. The baseline generator component 420 stores the baseline environmental state data using the data component 410. Similarly, the current data generator component 422 uses the input components 402-408 to generate a set of environmental state data representing the current time.

The environmental detection component 412 also includes a change detector component 424, which is configured to detect changes in the local environment between the baseline and the current time. The change detector component 424 includes a number of submodules to enable it to execute its functions. The change detector component 424 includes an image change detector 426, which is configured to compare image data from the current environmental state data to image data from the baseline environmental state data. The change detector component 424 also includes an audio change detector component 428, which compares audio data from the current environmental state data to audio data from the baseline environmental state data. Similarly, the change detector component 424 also includes a motion change detector component 430, which compares motion data from the current environmental state data to motion data from the baseline environmental state data. Of course, the system may be configured with fewer submodules to analyze fewer types of input data (e.g. if the system does not include a motion detector). The system may also include additional submodules to analyze data received from other sensor devices. The results produced by the change detector component 424 and its submodules 426-430 are then provided to the mode evaluation component 414 for evaluation.

The components of the system 400 may be implemented using software components executing on a general-purpose processor. The software code to support the functionality of this system may be stored on a computer-readable medium such as an optical drive, flash memory, or a hard drive. In addition, some or all of the components may be implemented partially or fully in hardware using an application-specific integrated circuit (ASIC), discrete components, a mixed-signal integrated circuit, or similar hardware components.

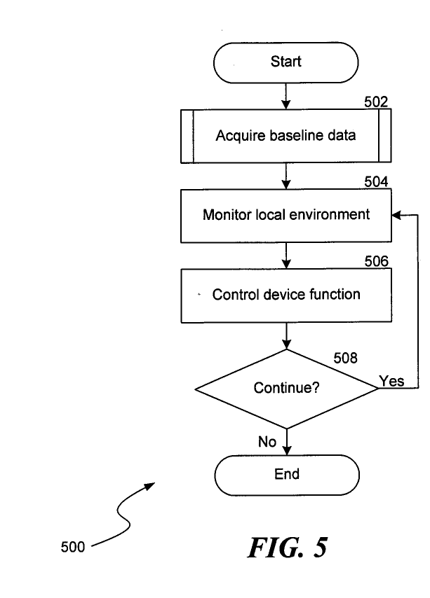

FIG. 5 illustrates a flowchart of a process 500 for implementing the environmental sensing system. The system begins processing in block 502, where it acquires the baseline environmental state data. As discussed above, the baseline data includes initial image, audio, motion, or other data about the local environment. After acquiring the baseline environmental state data, the system proceeds to block 504, where it monitors the local environment for change or lack of change. The monitoring process may include repeating a detection process to determine if the local environment is quiescent for a specified period. For example, the mode evaluation component 414 may be configured to query the environmental detection component 412 at a regular interval (e.g. every half-second) to determine if the local environment has changed and to trigger a change in mode based on the results of the query. In general, the system exits block 504 when the mode evaluation component 414 detects that the system should change between low presence mode and high presence mode.

If the system detects a change in mode, it proceeds to block 506, where the device reconfiguration component 416 controls the device function according to the settings stored in the data component 410. Controlling device function may include enabling or disabling particular hardware components of the mobile device 100. The system may also activate or deactivate particular software applications or reconfigure active software applications. In a particular implementation, this may include automatically redirecting incoming calls to voicemail or other applications. After controlling device function in block 506, the system proceeds to block 508, where it determines whether to continue processing. If the system determines that it should continue processing, it returns to block 504 to repeat the step of monitoring the local environment. Otherwise, the system proceeds to the end of the process and exits.

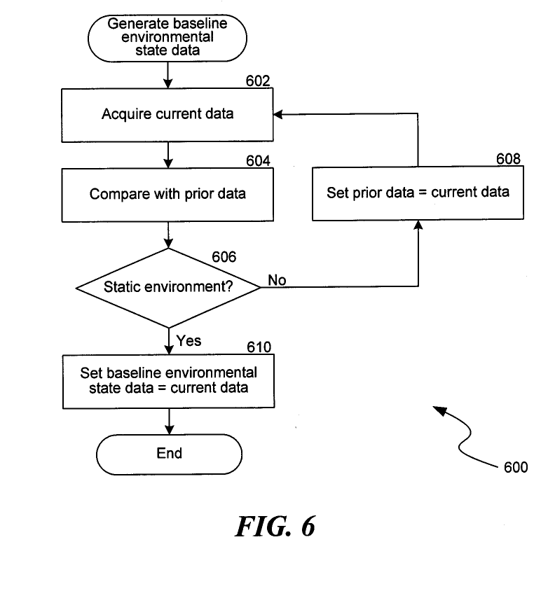

FIG. 6 illustrates a flowchart of a process 600 implemented by the baseline generator component for generating baseline environmental state data. The process 600 is designed to determine the baseline environmental state data at a point in time where the local environment is generally static. The system begins processing in block 602, where it acquires current data from the input components 402-408. After acquiring current data, the system proceeds to block 604, where it compares current data with prior data. The system compares the current data with the prior data to determine if the data differs to a degree indicating continuing activity in the local environment. In general, this may include calculating one or more metrics based on the current previous data and comparing the values of the metrics. The system may then determine that the environment is static if the metrics differ by less than a specified threshold. For example, the system may compare image data by determining a difference image between the current image and the prior image. A difference image can be generated by subtracting corresponding pixels between the two images. Thus, the difference image shows only the elements of the camera's field or view that have changed in between the two images. The system may then evaluate the difference by summing the pixel values in the difference image and comparing the sum to a threshold value. The threshold value may be chosen experimentally based on repeated processing of expected scenarios or it may be determined theoretically based on expected signal-to-noise ratio or other theoretical calculations. The comparison may be done similarly for motion data or for audio data.

The system then proceeds to decision block 606, where it branches depending on whether the comparison with prior data indicates that the local environment is substantially static. If the comparison shows that the environment is not static, the system proceeds to block 608, where it sets the prior data equal to the current data. The system then repeats the steps 602 through 606 in a loop until it detects a static environment. The system may be configured to perform this loop at a set interval or continuously. If the system determines in block 606 that the local environment has not changed, processing continues in block 610, where the system stores the current data as the baseline environmental state data. The system may also be configured to require that the environment be static for a specified period of time (e.g. five seconds or a minute) before storing the current data as the baseline environmental state data.

Alternatively, the system may be configured with a set of default values to define part or all of the baseline environmental state data. For example, the system may be configured to assume that the baseline level of motion is zero motion. Thus, any motion would indicate activity in the local environment. Similarly, the system may be configured with default baseline audio values. For example, the system may define a default threshold audio volume below which it can conclude that there is no activity in the local environment. The system may also be configured to immediately store current data as the baseline environmental state data without waiting for a static local environment.

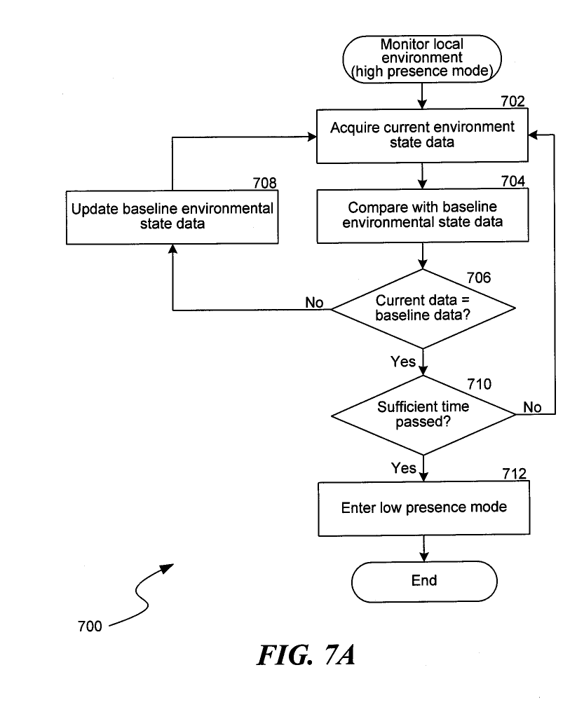

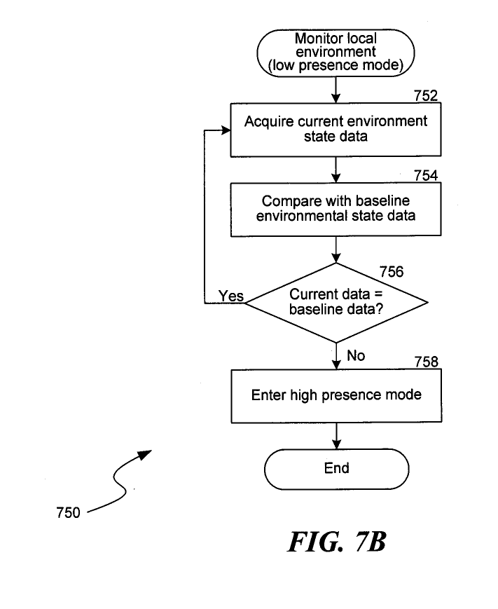

FIG. 7A illustrates a flowchart of a process 700 for monitoring the local environment when the system is operating in a high presence mode. The system operates in high presence mode when the system has determined there is activity in the local environment. The system begins processing at block 702, where it acquires current environmental state data. As discussed above, current environmental state data includes image data, audio data, and motion data from the inputs components 402-406 (FIG. 4). After acquiring current environment data, the system proceeds to block 704, where it compares the current environment state data with the baseline environmental state data. This may be done using similar methods to those used to generate the baseline environmental state data. For example, the system may compare image data using the difference image method described above. The system may use the same threshold values for the comparison as used in FIG. 6 or may use different values. In the case of audio data, the comparison could also include comparing the current audio data to the baseline according to amplitude, pitch, or other audio parameters.

After comparing with baseline data, the system proceeds to decision block 706, where it determines if the current data is substantially equal to the baseline data. As discussed above, the system may be configured to allow variation within a specified range rather than require that there be no change at all. If the system finds that the current data is not equal to the baseline data, it proceeds to block 708, where it updates the baseline environmental state data. The system may repeat the baseline determination process of FIG. 6 or may immediately store the current data as the updated baseline environmental state data. Alternatively, the system may skip block 708 to retain the previous baseline environmental state data. The system then returns to block 702, where it acquires and processes new current environmental state data. As with the baseline determination, the system may loop at a specified interval or continuously.

If the system finds that the current data is equal to the baseline data, it proceeds to decision block 710, where it determines if the local environment has been static for a sufficient time. This helps to avoid a situation where the system switches modes in response to a momentary cessation in activity and has to quickly switch back when activity resumes. If the system finds that sufficient time has not yet passed, it returns to block 702, where it acquires a new set of current environmental data. The system then repeats blocks 702 through 710 until it either detects data indicating that the environment is not static or until sufficient time has passed. When sufficient time has passed, the system proceeds to block 712, where it enters low presence mode. Entering low presence mode includes changing the system's mode and reconfiguring aspects of the mobile device 100.

FIG. 7B illustrates a flowchart of a process 750 for monitoring the local environment while operating in low presence mode. The system begins processing in block 752, where it acquires current environmental state data. After acquiring current environmental data, the system proceeds to block 754, where it compares the current environmental state data with the baseline environmental state data. This comparison may use the same methods discussed above with reference to block 704. After comparing, the system proceeds to decision block 756, where it determines if the current environmental state data is substantially equal to the baseline environmental state data. If the system finds that the current data is substantially equal to the baseline data, it returns to block 752 and repeats blocks 752-756 until it detects activity. Otherwise, the system determines that there is significant activity in the local environment and proceeds to block 708, where it enters high presence mode. Entering high presence mode includes reconfiguring the mobile device 100. For example, on entering high presence mode, the system may reconfigure the mobile device 100 to reverse the changes made when entering low presence mode. Because the process 750 of FIG. 7B does not require that the activity be present for a minimum period of time, the system will be quicker to exit low presence mode than it was to enter into low presence mode. This makes it less likely that the mobile device 100 will remain in low presence even after the user returns. However, the process 750 could be modified to also require that activity be present for a minimum time period similar to the minimum time required to enter low presence mode in FIG. 7A.

It will be appreciated that the environmental sensing system may reconfigure the system in a number of ways when it enters low presence mode. For example, the system may raise or lower the volume of the mobile device. The system may also automatically forward incoming calls to another telephone number or send the calls directly to the user's voice mail. The system may pause or stop currently running applications, such as by pausing playback of music or video files by a media player application. The system may automatically send a specified message in reply to received short message service (SMS) messages. The system may also disable unneeded hardware components and network services. For example, it could disable the wireless connection completely or simply disable a direct push service during low presence mode. The system could also disable the GPS receiver to preserve battery life.

Similarly, when returning to high presence mode, the system may automatically reverse the configuration changes made when entering low presence mode. The system may also present the user with information relating to the mobile device's activity during the time the user was not present. For example, the system may automatically display a list of missed telephone calls on the screen when it detects activity in the environment.

From the foregoing, it will be appreciated that specific embodiments of the invention have been described herein for purposes of illustration, but that various modifications may be made without deviating from the spirit and scope of the invention. Accordingly, the invention is not limited except as by the appended claims.

I/We claim:

1. An apparatus in a mobile device for modifying device configuration based on information about a local environment near the mobile device, comprising:
a sensor device configured to receive input environmental data from the local environment;
a baseline generator component configured to determine a baseline environmental state based at least in part on input environmental data received at a first time;
a current data generator component configured to determine a current environmental state based at least in part on input environmental data received at a second time;
a change detector configured to compare the baseline environmental state to the current environmental state;
a mode determination component configured in a first mode to generate a low presence indication if the comparison indicates there is substantially no activity in the local environment;
a device reconfiguration component configured to execute a first set of configuration changes to the mobile device in response to the low presence indication.

2. The apparatus as claimed in claim 1, wherein:
the mode determination component is further configured in a second mode to generate a high presence indication if the comparison indicates there is activity in the local environment; and
the device reconfiguration component is further configured to execute a second set of configuration changes in response to the high presence indication.

3. The apparatus as claimed in claim 1, wherein the sensor device is an image sensor and wherein the baseline generator component is configured to determine baseline environmental state by storing an image representing a field of view of the image sensor at the first time if the field of view is substantially static for a specified period of time before the first time.

4. The apparatus as claimed in claim 1, wherein the mode determination component is further configured to generate the low presence indication only if the second time occurs more than a specified time period after the first time.

5. The apparatus as claimed in claim 1, wherein the sensor device is an audio sensor and the baseline generator component is configured to determine the baseline environmental state by storing data representing one or more characteristics of the audio in the local environment.

6. The apparatus as claimed in claim 1, wherein the first set of configuration changes includes at least one of pausing execution of a currently running application, stopping execution of the currently running application, changing sound settings of the mobile device, configuring the mobile device to redirect incoming telephone calls, and disabling a hardware component of the mobile device.

7. A method in a mobile device for modifying device configuration based on information about a local environment near the mobile device, comprising:
determining a baseline environmental state based at least in part on input environmental data received at a first time;
determining a current environmental state based at least in part on input environmental data received at a second time;
comparing the current environmental state to the baseline environmental state;
if the comparison indicates substantially no activity in the nearby environment, entering a low presence mode, wherein entering the low presence mode comprises executing a first set of configuration changes to the mobile device.

8. The method as claimed in claim 7,
wherein determining the baseline environmental state comprises storing an image representing a field of view of an image sensor associated with the mobile device, and
wherein the image is stored if the field of view is substantially static for a specified time period.

9. The method as claimed in claim 7, wherein determining the baseline environmental state comprises storing an image representing a field of view of an image sensor associated with the mobile device.

10. The method as claimed in claim 7, wherein comparing comprises determining if the first time occurs more than a specified time period after the second time.

11. The method as claimed in claim 7, further comprising:
in low presence mode, determining a second current environmental state based at least in part on input environmental data received at a third time;
comparing the second current environmental state to the baseline environmental state; and
if the comparison indicates substantial activity in the environment, entering a high presence mode, wherein entering the high presence mode includes executing a second set of configuration changes to the mobile device.

12. The method as claimed in claim 7, wherein the baseline environmental state includes data representing audio in the local environment and wherein determining the baseline environmental state comprises storing data representing one or more characteristics of the audio in the local environment.

13. The method as claimed in claim 7, wherein the first set of configuration changes includes at least one of pausing execution of a currently running application, stopping execution of the currently running application, changing sound settings of the mobile device, configuring the mobile device to redirect incoming calls, and disabling a hardware component of the mobile device.

14. A computer-readable storage medium containing instructions for controlling a computer system to modify device configuration based on environmental information, by a method comprising:
determining a baseline environmental state based at least in part on input environmental data received at a first time;
determining a current environmental state based at least in part on input environmental data received at a second time;
comparing the current environmental state to the baseline environmental state;
if the comparison indicates substantially no activity in the nearby environment, entering a low presence mode, wherein entering the low presence mode comprises executing a first set of configuration changes to the mobile device.

15. The computer-readable storage medium as claimed in claim 14,
wherein determining the baseline environmental state comprises storing an image representing a field of view of an image sensor associated with the mobile device, and
wherein the image is stored if the field of view is substantially static for a specified time period.

16. The computer-readable storage medium as claimed in claim 14, wherein determining the baseline environmental state comprises storing an image representing a field of view of an image sensor associated with the mobile device.

17. The computer-readable storage medium as claimed in claim 14, wherein comparing comprises determining if the first time occurs more than a specified time period after the second time.

18. The computer-readable storage medium as claimed in claim 14, wherein the baseline environmental state includes data representing motion of the mobile device and wherein determining the baseline environmental state comprises storing data representing a baseline level of motion of the mobile device.

19. The computer-readable storage medium as claimed in claim 14, the method further comprising:
in low presence mode, determining a second current environmental state based at least in part on input environmental data received at a third time;
comparing the second current environmental state to the baseline environmental state; and
if the comparison indicates substantial activity in the environment, entering a high presence mode, wherein entering the high presence mode includes executing a second set of configuration changes to the mobile device.

20. The computer-readable storage medium as claimed in claim 14, wherein the first set of configuration changes includes at least one of pausing a currently running application, stopping execution of the currently running application, changing sound settings of the mobile device, configuring the mobile device to redirect incoming calls, and disabling a hardware component of the mobile device.
